(19) United States
(12) Patent Application Publication
(10) Pub. No.: US 2006/0110183 A1
(43) Pub. Date: May 25, 2006

(54) Image forming apparatus

(75) Inventor: Myung-Woo Yang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/180,627

(22) Filed: Jul. 14, 2005

(30) Foreign Application Priority Data
Nov. 23, 2004 (KR) 2004-96155

(51) Int. Cl. G03G 21/00

(52) U.S. Cl. 399/124

(57) ABSTRACT

There is provided an image forming apparatus. In the image forming apparatus, a paper feeder is detachably installed in the image forming apparatus and feeds the paper to the image forming unit. The paper feeder comprises a first paper feed unit for feeding the paper to the image forming unit along a first paper passage and a second paper feed unit for feeding the paper to the image forming unit along a second paper passage. Also, the paper feeder comprises a guide surface that forms a portion of the paper passage. Therefore, jammed paper can be easily removed after pulling the paper feeder out of the image forming apparatus, thereby increasing the stability of the image forming apparatus and user's convenience. Further, jammed paper at the first paper passage and/or the second paper passage can be easily removed due to the integral form of the first and second feed unit.

### BACKGROUND OF THE INVENTION

This application claims the benefit under 35 U.S.C. 119 (a) of Korean Patent Application No. 10-2004-0096155, filed on Nov. 23, 2004, in the Korean Intellectual Property Office, the disclosure of which is incorporated herein in its entirety by reference.

1. Field of the Invention

The present invention relates to an image forming apparatus. More particularly, the present invention relates to a paper feeder of an image forming apparatus, which is designed to easily remove jammed paper.

2. Description of the Related Art

Typically, an image forming process of an image forming apparatus includes charging a photoconductor to have a predetermined electrical potential, exposing the charged photoconductor to light to form an electrostatic latent image by using a light scanning unit such as a laser scanning unit (LSU), developing the latent image into a visible toner image by applying a toner (developer) to the latent image on the photoconductor, feeding paper from a paper feeder along a feeding passage, transferring the toner image from the photoconductor to the fed paper, fusing the transferred toner image onto the paper by applying heat and pressure, and outputting the fused paper.

FIG. 1 is a diagram illustrating a jammed paper that is not completely passed through feed rollers, and FIG. 2 is a view showing a jammed paper after the paper is completely passed through feed rollers.

Referring to FIGS. 1 and 2, paper (P) stacked in a paper feeder 10 is picked up by a pick-up roller 20 and conveyed toward an image forming unit along a predetermined feeding passage by feeding rollers 30 and 40. When the paper (P) is jammed before completely passing through the feed rollers 30 and 40 (FIG. 1), the user removes the paper feeder 10 from an image forming apparatus and pulls out the jammed paper (P). This is not convenient to the user. Also, it is hard to pull out the jammed paper because the paper is tightly disposed between the feed rollers 30 and 40.

When the paper (P) is jammed after it has completely passed through the feed rollers 30 and 40 (FIG. 2), the jammed paper (P) cannot be removed in the previously discussed manner. Therefore, the user opens a cover at a side of the image forming apparatus and then removes the jammed paper. However, this makes it more difficult for the user to remove the jammed paper.

Thereore, a need exists for an apparatus that allows the easy removal of jammed paper.

### SUMMARY OF THE INVENTION

The present invention provides an image forming apparatus, in which a paper feeder is designed such that jammed paper can be easily removed.

According to an aspect of the present invention, there is provided an image forming apparatus comprising an image forming unit for forming an image on paper; and a paper feeder coupled to in the image forming apparatus for feeding the paper to the image forming unit, the paper feeder having a first paper feed unit for feeding the paper to the image forming unit along a first paper passage, and a second paper feed unit for feeding the paper to the image forming unit along a second paper passage. The paper feeder, for example, is detachably installed in the image forming apparatus.

The first paper feed unit may be disposed at a lower portion of the paper feeder and the second paper feed unit may be disposed at a side of the paper feeder.

The first paper feed unit may comprise a paper loading unit in which the paper is loaded.

The first paper feed unit and the second paper feed unit may be integrally assembled.

The paper feeder may comprise a first guide surface that forms a portion of the first paper passage, the first guide surface guiding the feeding of the paper.

The paper feeder may comprise a guide member movably installed to the second paper feed unit to guide the paper of the second paper feed unit

The first paper feed unit may feed regular size paper and the second paper feed unit may feed regular size paper and irregular size paper.

The second paper passage may be located above the second paper feed unit.

The paper feeder may comprise a second guide surface that forms a portion of the second paper passage, the second guide surface guiding the feeding of the paper.

The second guide surface may be removable from the image forming apparatus through an associated motion with the paper feeder.

According to another aspect of the present invention, there is provided an image forming apparatus comprising: an image forming unit forming an image on paper; and a paper feeder feeding the paper to the image forming unit along a predetermined paper passage, wherein the paper feeder forms a portion of the predetermined paper passage and comprising a guide surface along which the feeding of the paper is guided.

The guide surface may be removable from the image forming apparatus through an associated motion with the paper feeder.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a jammed paper that is not completely passed through feed rollers in accordance with the prior art;

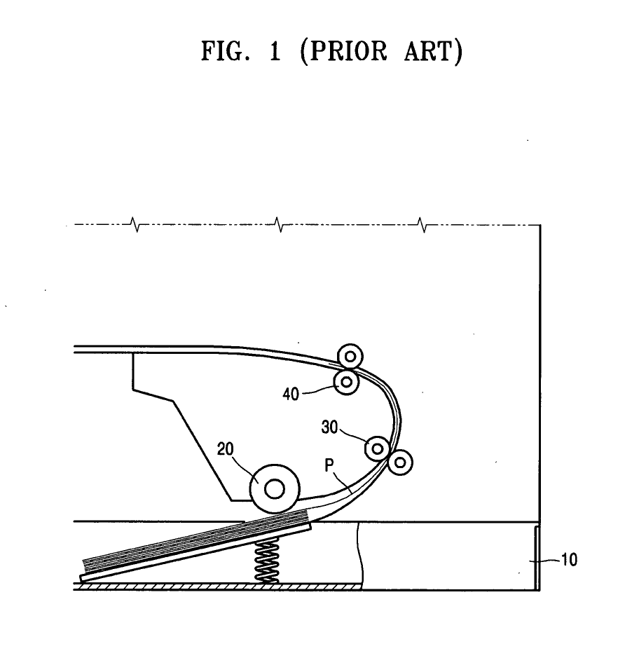

FIG. 2 is a diagram illustrating a jammed paper after the paper is completely passed through feed rollers in accordance with the prior art;

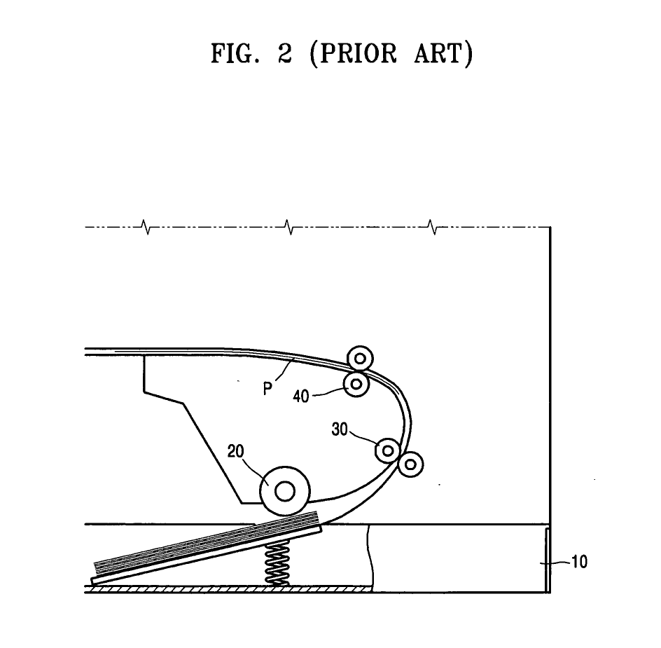

FIG. 3 is a diagram illustrating a two-pass type image forming apparatus with a paper feeder according to an embodiment of the present invention;

FIG. 4 is a diagram illustrating an enlarged partial view of an image forming apparatus depicted in FIG. 3, showing a construction of a paper feeder according to an embodiment of the present invention;

FIG. 5 is a diagram illustrating a paper feed depicted in FIG. 4 when the paper is removed from an image forming apparatus according to an embodiment of the present invention;

FIG. 6 is a diagram illustrating a side view of an image forming apparatus depicted in FIG. 3 according to an embodiment of the present invention;

FIG. 7 is a diagram illustrating a two-pass type image forming apparatus with a paper feeder according to another embodiment of the present invention;

FIG. 8 is a diagram illustrating an enlarged partial view of an image forming apparatus depicted in FIG. 7, showing a construction of a paper feeder according to an embodiment of the present invention; and

FIG. 9 is a diagram illustrating a paper feed depicted in FIG. 8 when the paper is removed from an image forming apparatus according to an embodiment of the present invention.

Throughout the drawings, the same or similar elements are denoted by the same reference numerals.

### DETAILED DESCRIPTION OF EXEMPLARY EMBODIMENTS OF THE INVENTION

A paper feeder of the present invention is used for an image forming apparatus such as a digital copier, an electrophotographic image forming apparatus, and a fax machine. A two-pass type image forming apparatus with a paper feeder is illustrated to describe embodiments of the present invention. However, the present invention is not limited to the illustrated two-pass type image forming apparatus and paper feeder.

The present invention will now be described more fully with reference to the accompanying drawings, in which exemplary embodiments of the invention are shown. In the drawings, the size of elements and thicknesses of lines are exaggerated for clarity.

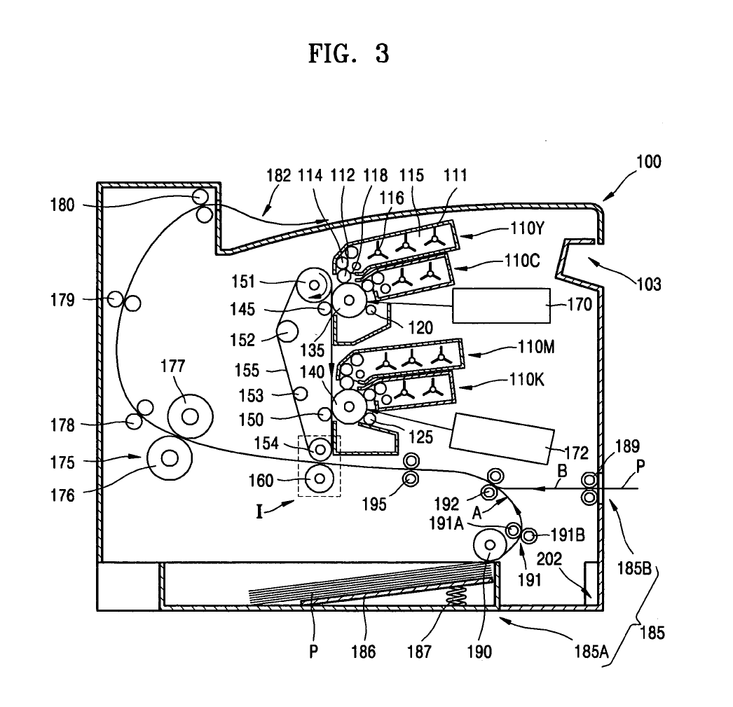

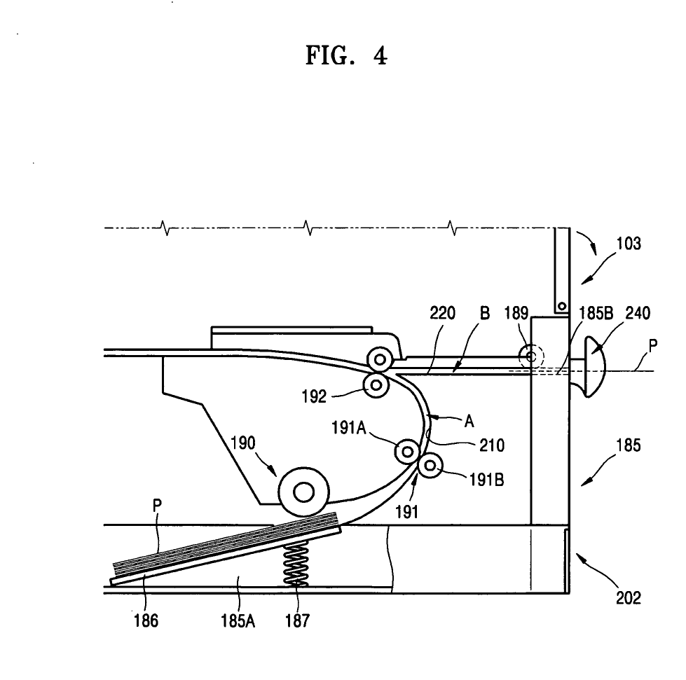

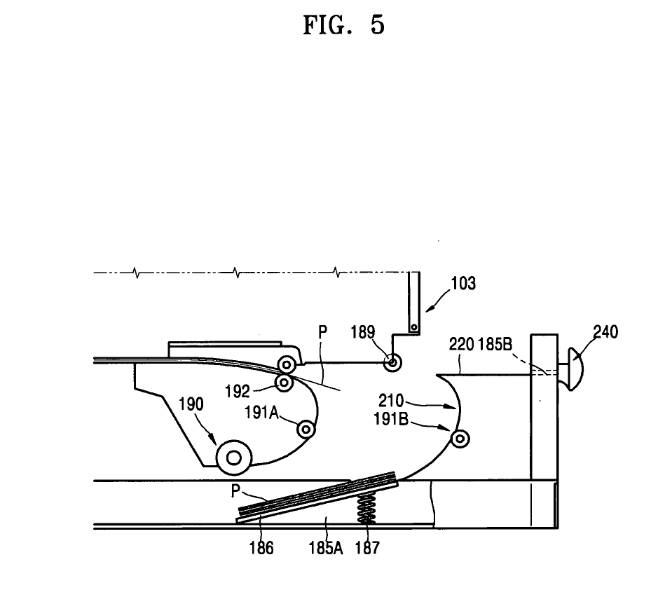

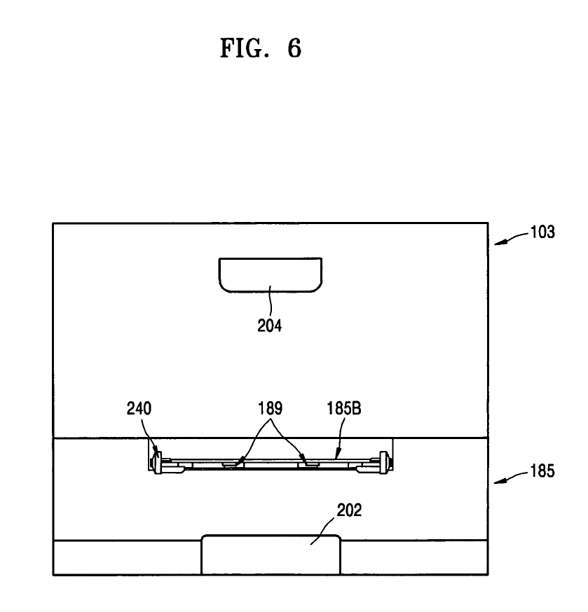

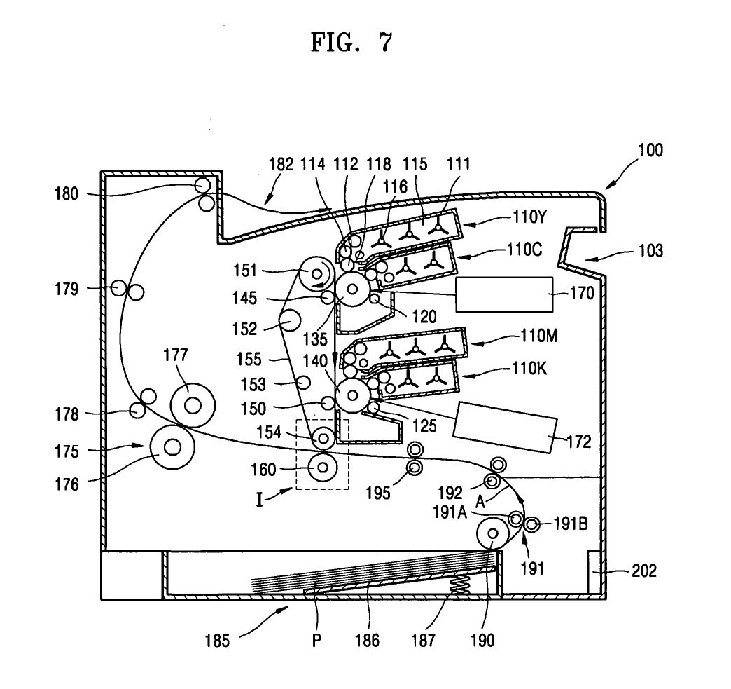

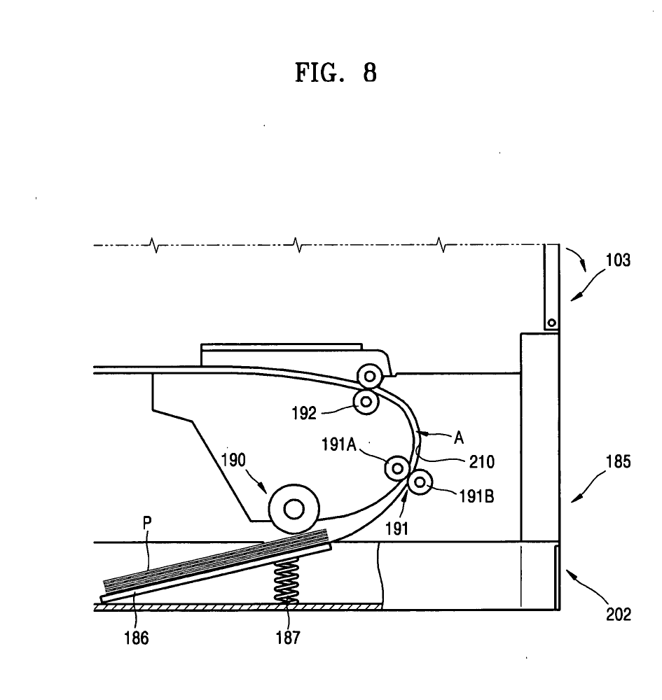

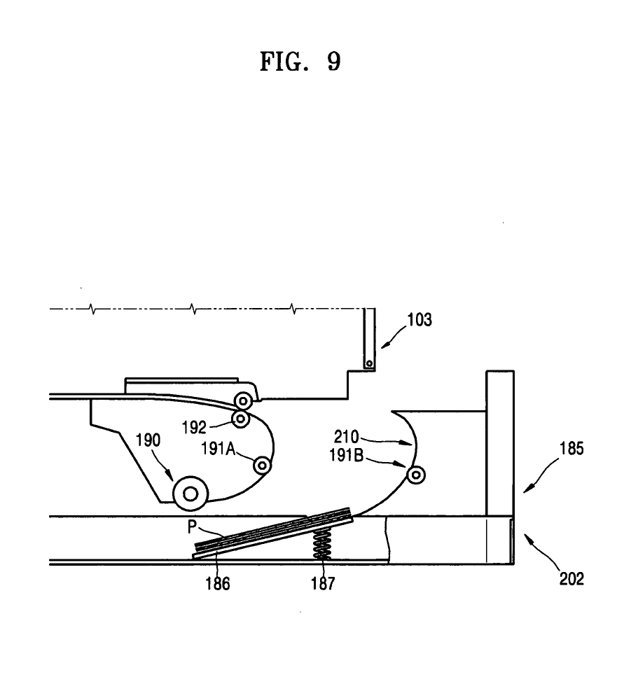

FIG. 3 is a diagram illustrating a two-pass type image forming apparatus with a paper feeder according to an embodiment of the present invention, FIG. 4 is a diagram illustrating an enlarged partial view of an image forming apparatus depicted in FIG. 3, showing a construction of a paper feeder, FIG. 5 is a diagram illustrating a paper feed depicted in FIG. 4 when the paper is removed from an image forming apparatus, FIG. 6 is a diagram illustrating an image forming apparatus depicted in FIG. 3, FIG. 7 is a diagram illustrating a two-pass type image forming apparatus with a paper feeder according to another embodiment of the present invention, FIG. 8 is a diagram illustrating an enlarged partial view of an image forming apparatus depicted in FIG. 7, showing a construction of a paper feeder, and FIG. 9 is a diagram illustrating a paper feed depicted in FIG. 8 when the paper is removed from an image forming apparatus.

A typical two-pass type image forming apparatus comprises two light scanning units and two photoconductors. Referring to FIG. 3, an image forming apparatus 100 comprises a first light scanning unit 170, a second light scanning unit 172, a first photoconductor 135, a second photoconductor 140, four development units 110Y, 110C, 110M, and 110K, a first transfer unit 145, a second transfer unit 150, an intermediate transfer belt (ITB) 155, a third transfer unit 160, a fuser 175, a paper feeder 185, and pick-up rollers 189 and 190.

The development units 110Y, 110C, 110M, and 110K, and the photoconductors 135 and 140 are limited to the illustrated structures and arrangements. That is, it will be apparent to those skilled in the art that various modifications and variations can be made.

A door 103 is provided at an upper portion of the image forming apparatus 100, for removing the development units 110Y, 110C, 110M, and 110K.

In response to control signals, the first light scanning unit 170 applies light corresponding to a first image data to the first photoconductor 135 in order to form a first electrostatic latent image, and the second light scanning unit 172 applies light corresponding to a second image data to the second photoconductor 140 in order to form a second electrostatic latent image. In this embodiment, the first and second light scanning unit 170 and 172 are laser scanning units (LSU), each using a laser diode as a light source.

Though the development units 110Y, 110C, 110M, and 110K are disposed at different locations, they have the same structure and perform substantially the same functions. Therefore, a description of the development unit 110Y will replace descriptions of other development units and, if necessary, other development units will be briefly described.

The development unit 110Y is detachably installed in the image forming apparatus 100 (cartridge type development unit). The development unit 110Y comprises a housing 111 forming the exterior, a development roller 112, a toner feed roller 114, a toner containing unit 115, an agitator 116, and a doctor blade 118. The toner containing unit 115 holds toner (developer).

The development roller 112 is abutted on the surface of the first photoconductor 135, or positioned off the surface of the first light scanning unit 170. The development roller 112 applies the toner of the toner containing unit 115 to the outer circumference of the development roller 112 and supplies the toner to the first photoconductor 135. Specifically, the toner in a powder form is transferred from the toner containing unit 115 to the development roller 112 and then supplied to the first electrostatic latent image formed on the first photoconductor 135 to develop a first toner image. A development bias voltage is applied to the development roller 112 to supply the toner to the first photoconductor 135.

The toner feed roller 114 supplies the toner to the development roller 112. The agitator 116 stirs the toner in the toner containing unit 115 to prevent the toner from hardening and moves the toner toward the toner feed roller 114.

The doctor blade 118 has one end fixed to the housing 111 and the other end abutted on the development roller 112. The doctor blade 118 regulates the thickness of the toner that is attached on the outer surface of the development roller 112. Also, the doctor blade 118 charges the toner to have a predetermined polarity as it rubs the toner.

Though the first and second photoconductor 135 and 140 are disposed at different locations, they have the same structure and perform substantially the same functions. Therefore, a description of the first photoconductor 135 will replace description of the second photoconductor 140 and, if necessary, the second photoconductor 140 will be briefly described.

Each of the photoconductors 135 and 140 comprises a metal drum and a photoconductive layer formed on the metal drum by deposition or the like. Some portions of the photoconductors 135 and 140 are exposed to the lights of the first and second light scanning unit 170 and 172, such that the photoconductors 135 and 140, as they rotate, receive the light on their whole outer surfaces. The photoconductors 135 and 140 are charged by first and second charge rollers 120 and 125, respectively. The charged photoconductor 135 and 140 form the first and second electrostatic latent images on their outer surfaces when the first and second light scanning units 170 and 172 apply the light in response to the control signal. Also, the outer surfaces of the photoconductors 135 and 140 are faced with the ITB 155.

The first and second charge rollers 120 and 125 are applied with discharge bias voltages to respectively charge the first and second photoconductors 135 and 140 to have uniform electrical potentials before the first and second light scanning units 170 and 172 apply light to the photoconductor 135 and 140. A corona charger (not shown) may be used instead of each of the charge rollers 120 and 125.

The ITB 155 comprises one side faced with the first and second photoconductors 135 and 140 and the other side faced with the first and second transfer units 145 and 150. The ITB 155 passes through between the first photoconductor 135 and first transfer unit 145 and through between the second photoconductor 140 and second transfer unit 150 as it rotates. A plurality of supporting rollers 151, 152, 153, and 154 are used to support the ITB 155.

The first and second transfer units 145 and 150 are faced with the first and second photoconductors 135 and 140 respectively while disposing the ITB 155 therebetween. The first and second transfer units 145 and 150 are applied with transfer bias voltages of which polarities are opposite to polarities of the first and second toner images on the first and second photoconductors 135 and 140, such that the toner images can be transferred to the ITB 155. That is, the first and second toner images on the first and second photoconductors 135 and 140 are directed to the ITB 155 by the electrostatic forces between the first photoconductor 135 and first transfer unit 145 and between the second photoconductor 140 and second transfer unit 150. Also, the first and second toner images may be transferred to the ITB 155 by the pressures or friction between the first photoconductor 135 and first transfer unit 145 and between the second photoconductor 140 and second transfer unit 150.

The third transfer unit 160 is engaged with the supporting roller 154 and applied with a transfer bias voltage of which polarity is opposite to the polarity of the toner image on the ITB 155, such that the toner image can be transferred from the ITB 155 to the paper (P) by an electrostatic force while the paper (p) passes through between the third transfer unit 160 and ITB 155.

Reference character “I” denotes an image forming unit in which the toner image is transferred to the paper (P). Though, the image forming unit (I) comprises the supporting roller 154 and third transfer unit 160 in this embodiment, various modifications and changes of the image forming unit (I) can be made according to the type of image forming apparatus.

The fuser 175 comprises a heat roller 176 and a pressure roller 177 that are parallel and facing each other. The fuser 175 applies heat and pressure to the toner image on the paper (P) to securely attach the image on the paper (P). The heat roller 176 applies the heat to the toner image, and the pressure roller 177 applies the pressure to the toner image while the paper (P) passes therethrough, such that the toner image can be melted on the paper (P) for a permanent attachment.

A flattening unit 178 flattens the paper (P) that is curled by heat of the fuser 175. Eject rollers 179 and 180 discharges the paper (P) out of the image forming apparatus 100 after the paper (P) is completely printed. The discharged paper (P) is collected at an output tray 182.

The paper feeder 185 is provided at a lower portion of the image forming apparatus 100 for storing blank paper.

Referring to FIGS. 3 and 4, the paper feeder 185 comprises a first paper feed unit 185A and a second paper feed unit 185B. The first and second paper feed units 185A and 185B are integrally formed or assembled.

The first paper feed unit 185A is provided to feed standard size paper such as A4 size paper. The first paper feed unit 185A comprises a paper loading unit 186 and an elastic member 187. The elastic member 187 biases the paper loading unit 186 toward a pick-up roller 190. The pick-up roller 190 is disposed above the first paper feed unit 185A, such that the paper (P) on the paper loading unit 186 can be abutted against the pick-up roller 190 by the elastic force of the elastic member 187. The pick-up roller 190 as it rotates conveys the paper (P) one by one toward a first paper passage (A). Feed rollers 191 and 192 convey the paper (P) from the pick-up roller 190 to a registration unit 195.

The second paper feed unit 185B is provided to feed paper of irregular size and thickness as well as the standard size paper. To print on irregular paper, the user loads the irregular paper one by one in the second paper feed unit 185B. A pick-up roller 189 is disposed above the second paper feed unit 185B to pick up the loaded paper and convey it to the feed roller 192 along a second paper passage (B). Though the second paper feed unit 185B is loaded with sheets of paper one by one, the present invention is not limited to this embodiment. The second paper feed unit 185B may be a multipurpose function (MPF) type paper feeder that is widely used for an image forming apparatus. Since the MPF type paper feeder is well known to those skilled in the art, a detailed description will be omitted. The first paper feed unit 185A may be placed at a lower portion of the paper feeder 185, and the second paper feed unit 185B may be placed at an upper portion of the paper feeder 185.

Referring to FIG. 5, the paper feeder 185 comprises a first guide surface 210 at a side. The first guide surface 210 forms a portion of the first paper passage (A). When the paper feeder 185 is removed from the image forming apparatus 100, the first guide surface 210 is also separated from the first paper passage (A). Preferably, the first guide surface 210 is smoothly curved to convey the paper (P) with ease, and a driven roller 191B of the feed rollers 191 is partially protruded from the first guide surface 210 and faced with a driving roller 191A of the feed rollers 191. Therefore, the paper (P) can be more smoothly conveyed toward the registration unit 195 along the first paper passage (A) owing to the driven roller 191B disposed at the first guide surface 210.

A second guide surface 220 is formed at an upper portion of the paper feeder 185 to form a portion of the second paper passage (B). When the paper feeder 185 is removed from the image forming apparatus 100, the second guide surface 220 is also separated from the second paper passage (B). Above the second guide surface 220, the pick-up roller 189 is installed to pick up the paper (P) from the second paper feed unit 185B toward the feed rollers 192 along the second paper passage (B). Also, a pressure element (not shown) facing the pick-up roller 189 may be disposed at the second guide surface 220 to apply pressure to the paper (P) when the paper (P) is conveyed by the pick-up roller 189. The pressure element may be a roller or a pad plate.

Referring to FIG. 6, a guide member 240 is movably installed at the second paper feed unit 185B to align the width of the paper (P) and guide the paper (P). The guide member 240 may be provided at each side of the second paper feed unit 185B.

An opening handle 204 is formed at an upper portion of the second paper feed unit 185B to open the door 103 of the image forming apparatus 100, and a hand griping portion 202 is formed at a lower portion of the paper feeder 185 to remove the paper feeder 185 from the image forming apparatus 100.

The paper (P), which is fed along the first paper passage (A) or second paper passage (B), is aligned by the registration unit 195. That is, the registration unit 195 aligns the paper (P) before the paper (P) passes between the supporting roller 154 and third transfer unit 160, such that the toner image can be more precisely transferred to a desired area of the paper (P). The registration unit 195 conveys the paper (P) to a nip point of the third transfer unit 160. The toner image on the ITB 155 is transferred to the paper (P) while the paper (P) is fed through between the ITB 155 and the third transfer unit 160.

The operation of the image forming apparatus will now be described more fully according to an embodiment of the present invention.

The first photoconductor 135 and second photoconductor 140 are uniformly charged by charge bias voltages applied to the first charge roller 120 and second charge roller 125. The first light scanning unit 170 applies light corresponding to yellow image to the first photoconductor 135, and the second light scanning unit 172 applies light corresponding to a magenta image to the second photoconductor 140. The light-exposed surfaces of the photoconductors 135 and 140 are selectively discharged, such that each photoconductor can have a pattern formed by electric potential difference. This pattern is called an electrostatic latent image.

Meanwhile, the agitator 116 stirs the toner in the toner containing unit 115, and the toner feed roller 114 supplies the toner to the development roller 112 to which development bias voltage is applied. The toners attached on the outer surface of the development roller 112 is regulated by the doctor blade 118 to have a thin thickness and are charged by the rubbing of the doctor blade 118.

When the first photoconductor 135 as it rotates comes into contact with the development unit 110Y, the development roller 112 of the development unit 110Y starts to rotate, and the development unit 110Y is applied with a development bias voltage, such that yellow toner can be applied on the electrostatic latent image on the first photoconductor 135 to form a yellow toner image.

Then, the yellow toner image reaches the ITB 155 by the rotation of the first photoconductor 135, and the yellow toner image is transferred to the ITB 155 by transfer bias voltage of the first transfer unit 145 and/or contact pressure between the first photoconductor 135 and first transfer unit 145.

As the ITB 155 rotates, the yellow toner image is completely transferred to the ITB 155 and the ITB 155 approaches the second photoconductor 140. When the ITB 155 comes into contact with the second photoconductor 140, the magenta toner image of the second photoconductor 140 is overlapped on the ITB 155. That is, the ITB 155 rotates one time to completely transfer the yellow and magenta toner images on the ITB 155.

In the same manner, cyan and black toner images are formed on the photoconductors 135 and 140 and transferred to the ITB 155. After four toner images are completely transferred on the ITB 155 (they are overlapped on the ITB 155 and therefore form one toner image with the desired colors), the toner image is transferred onto the paper (P).

The paper (P) is picked up from the paper feeder 185 by the pick-up roller 189 or pick-up roller 190 and then conveyed toward the registration unit 195. The registration unit 195 aligns the paper (P) and feeds it to the supporting roller 154 and third transfer unit 160. When the leading end of the paper print area is conveyed to the nip point between the third transfer unit 160 and supporting roller 154, the leading end of the toner image on the ITB 155 is also conveyed to the nip point at the same time.

As the paper (P) passes through between the ITB 155 and third transfer unit 160, the toner image is transferred from the ITB 155 to the paper (P) by the transfer bias voltage applied to the third transfer unit 160.

The remaining toner on the ITB 155 after the transferring is removed by a cleaning unit (not shown) and collected at a waste toner collector (not shown). The fuser 175 applies heat and pressure to the toner image on the paper (P) to securely adhere the toner image to the paper. The flattening unit 178 flattens the paper (P) that is curled at the fuser 175. The paper (P) passed through the flattening unit 178 is discharged from the image forming apparatus 100 by the eject rollers 180. The discharged paper (P) is stacked on the output tray 182. In the two-pass image forming apparatus, the ITB 155 and the photoconductors 135 and 140 is rotated twice to form a complete toner image on the ITB 155.

The paper (P) can be jammed while it is picked up from the paper feeder 185 and conveyed along the first paper passage (A) or the second paper passage (B). Referring to FIG. 6, the paper feeder 185 can be easily removed from the image forming apparatus 100 when the paper (P) is jammed while passing through the feed rollers 191 and 192. That is, since the first guide surface 210 and second guide surface 220 are separated from the image forming apparatus 100 when the paper feeder 185 is removed from the image forming apparatus 100, such that the first paper passage (A) and second paper passage (B) are exposed. Therefore, the user can easily remove the jammed paper through the exposed passages (A) and (B).

Hereinafter, a paper feeder and an image forming apparatus using the paper feeder will be described with reference to the accompanying drawings according to another embodiment of the present invention. The same elements will be denoted with the same reference numerals, and since the overall construction and operation of the image forming apparatus is the same as described above, their description will be omitted.

The first guide surface 210 forms a portion of the first paper passage (A). When the paper feeder 185 is removed from the image forming apparatus 100, the first guide surface 210 is also separated from the first paper passage (A). Preferably, the first guide surface 210 is smoothly curved to convey the paper (P) with ease, and a driven roller 191B of the feed rollers 191 is partially protruded from the first guide surface 210 and faced with a driving roller 191A of the feed rollers 191. Therefore, the paper (P) can be more smoothly conveyed toward the registration unit 195 along the first paper passage (A) owing to the driven roller 191B disposed at the first guide surface 210.

Referring to FIGS. 7 through 9, a hand griping portion 202 of a paper feeder 185 is used to remove and install the paper feeder 185 from and to the image forming apparatus 100. The paper feeder 185 comprises a paper loading unit 186 and an elastic member 187. The elastic member 187 biases the paper loading unit 186 toward a pick-up roller 190. The pick-up roller 190 is disposed above the paper feeder 185, such that the paper (P) on the paper loading unit 186 can be abutted against the pick-up roller 190 by the elastic force of the elastic member 187. The pick-up roller 190 as it rotates conveys the paper (P) one by one toward a paper passage (A). Feed rollers 191 and 192 convey the paper (P) from the pick-up roller 190 to the registration unit 195.

A guide surface 210 is formed at a side of the paper feeder 185 and forms a portion of the first paper passage (A). When the paper feeder 185 is removed from the image forming apparatus 100, the guide surface 210 is also separated from the paper passage (A). Preferably, the guide surface 210 is smoothly curved to convey the paper (P) with ease, and a driven roller 191B of the feed rollers 191 is partially protruded from the guide surface 210 and faced with a driving roller 191A of the feed rollers 191. Therefore, the paper (P) can be more smoothly conveyed toward the registration unit 195 along the paper passage (A) owing to the driven roller 191B disposed at the first guide surface 210. The paper (P) conveyed along the paper passage (A) is aligned by the registration unit 195.

As described above, a portion of the paper feeder of the image forming apparatus is designed to form a paper passage, such that jammed paper can be easily removed after pulling the paper feeder out of the image forming apparatus.

Further, the ease of removing the jammed paper increases the stability of the image forming apparatus and user's convenience. Furthermore, the first paper feed unit and second paper feed unit are integrally formed, such that the jammed paper at the first paper passage or the second paper passage can be easily removed by pulling the paper feeder out of the image forming apparatus. In addition, the integral form of the first and second paper feed units can reduce the cost of materials.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
an image forming unit forming an image on paper; and
a paper feeder coupled to the image forming apparatus for feeding the paper to the image forming unit,
wherein the paper feeder comprises
a first paper feed unit for feeding the paper to the image forming unit along a first paper passage;
a second paper feed unit for feeding the paper to the image forming unit along a second paper passage; and
a guide member movably installed at the second paper feed unit for aligning the width of the paper that is fed to the second paper feed unit and guiding the paper.

2. The image forming apparatus of claim 1, wherein the first paper feed unit is disposed at a lower portion of the paper feeder and the second paper feed unit is disposed at a side of the paper feeder.

3. The image forming apparatus of claim 2, wherein the first paper feed unit comprises a paper loading unit in which the paper is loaded.

4. The image forming apparatus of claim 3, wherein the first paper feed unit and the second paper feed unit are integrally assembled.

5. The image forming apparatus of claim 4, wherein the paper feeder comprises a first guide surface that forms a portion of the first paper passage, the first guide surface guiding the feeding of the paper.

6. The image forming apparatus of claim 5, wherein the first paper feed unit feeds regular size paper and the second paper feed unit feeds standard size paper and nonstandard size paper.

7. The image forming apparatus of claim 6, wherein the second paper passage is located above the second paper feed unit.

8. The image forming apparatus of claim 2, wherein the paper feeder comprises a second guide surface that forms a portion of the second paper passage, the second guide surface guiding the feeding of the paper.

9. The image forming apparatus of claim 8, wherein the first paper feed unit and the second paper feed unit are integrally assembled.

10. The image forming apparatus of claim 9, wherein the second guide surface is removable from the image forming apparatus through an associated motion with the paper feeder.

11. The image forming apparatus of claim 10, wherein the second paper passage is located above the second paper feed unit.

12. The image forming apparatus of claim 1, wherein the paper feeder is detachably installed in the image forming apparatus.

13. The image forming apparatus of claim 10, wherein standard size paper Comprises letter size, legal size, A4 size paper.

14. An image forming apparatus comprising:
an image forming unit for forming an image on paper; and
a paper feeder for feeding the paper to the image forming unit along a predetermined paper passage, wherein the paper feeder forms a portion of the paper passage and comprises a guide surface along which the feeding of the paper is guided.

15. The image forming apparatus of claim 14, wherein the guide surface is removable from the image forming apparatus through an associated motion with the paper feeder.
